(19) United States
(12) Patent Application Publication
(10) Pub. No.: US 2003/0056031 A1
(43) Pub. Date: Mar. 20, 2003

(54) Method and system for monitoring data transmission using differential transmission methods with a direct voltage portion

(76) Inventors: Jorg Dauerer, Groebenzell (DE); Frank Siebler, Munich (DE); Gerhard Steib, Munich (DE)

Correspondence Address: STAAS & HALSEY LLP, 700 11TH STREET, NW, SUITE 500, WASHINGTON, DC, 20001, US

(21) Appl. No.: 10/149,761

(22) PCT Filed: Dec. 11, 2000
(86) PCT No.: PCT/DE00/04403

(30) Foreign Application Priority Data
Dec. 13, 1999 (DE) 19959982.3

(51) Int. Cl. G06F 3/00

(52) U.S. Cl. 710/1

(57) ABSTRACT

During the transmission of signals using differential transmission methods a direct voltage portion of the signal is used downstream. The direct voltage portion is used on the receiver side to provide information concerning the operational state of the transmitter. To do this, a pair of serially arranged resistors may be connected in parallel with the receiver. A detector may be connected between the resistors.

The invention relates to a method for monitoring the transmission of analog or digital signals by means of differential transmission methods with a DC voltage component and to a circuit arrangement for carrying out the method.

Data transmission methods are known in which differential transmission methods with DC voltage components are used. These methods have little susceptibility to disturbances which act in the same way on both transmission lines.

In the case of such differential transmission, the analog or digital signal to be transmitted controls two transmitter outputs A and AN, which operate in opposite senses to one another.

By way of example, for transmitting a digital signal with the logic states (0, 1), the output A acts, for example, as a current source, while the output AN acts as a current sink, and vice-versa. The transmitter provides a current of an appropriate magnitude and direction, in order to produce the voltage Ud across the resistance R.

The transmitter also produces a DC voltage component Uc. Ideally, this DC voltage component Uc is independent of the transmission and has a constant value, which provides the axis of symmetry of the eye opening at the receiver input.

The difference between the input voltages UE and UEN is formed in the receiver. This voltage difference corresponds to the value Ud across the resistance R. When transmitting digital signals, the difference is amplified and is assigned to the logic states (0, 1) on the basis of a threshold value decision.

For the example in which a digital signal is transmitted, the output of the receiver produces the logic state (1) when the difference between the input voltages UE and UEN is, for example, positive. If the difference between the input voltages UE and UEN is negative, the logic state (0) appears at the output of the receiver.

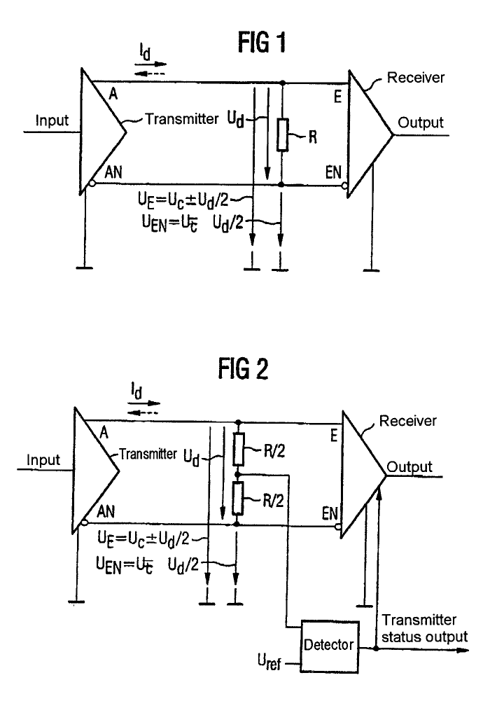

FIG. 1 illustrates a known circuit arrangement for carrying out a differential transmission method with a DC voltage component.

Worthwhile data transmission between assemblies is possibly only when the transmitter and the receiver are in their active operating state.

However, a problem frequently arises when the transmitter is either not present at all (for example no transmission assembly has been used) or is not being powered (for example a transmission assembly has been used, but has no supply voltage), or is in the high-impedance state (for example the outputs of the transmitter are switched off).

As a consequence, there is no sensible reference between the inputs E and EN of the receiver and ground potential. Since these are open inputs, radio-frequency oscillation can occur in the broadband receiver. Depending on the use of the data at the output of the receiver (for example as a clock supply for an assembly), this can lead to destruction of the receiver or of the assembly.

Until now, the procedure to avoid these disadvantages has been as follows:

The receiver is provided with hysteresis. In this case, the difference voltage formed in the receiver is supplied to a threshold value decision making process with this hysteresis.

However, this has the disadvantage that the output of the receiver remains in a stable state only when the differential disturbances are less than the hysteresis setting.

The receiver is provided with a bias voltage by a suitably chosen current flow through the resistance R.

In this case as well, the output of the receiver remains in a stable state only when the differential disturbance is less than the bias voltage setting. Furthermore, the bias voltage results in a difference voltage magnitude |Ud| which is dependent on the data and, associated with this, a better/poorer signal-to-noise ratio.

Information about the operating state of the transmitter (for example the transmitter is active/the transmitter has a high impedance/the transmitter is switched off/the transmitter is not connected) is transmitted via additional control lines.

This information can be used to take precautions to suppress radio-frequency oscillation of the transmitter and to prevent possible damage or destruction of it, or of the downstream assembly.

However, the use of such additional control lines results in increased costs for material and for the installation of said lines.

None of the measures described above ensure optimum operation of the method, and they all require considerable additional complexity.

The invention is therefore based on the object of avoiding the disadvantages described above and of minimizing the necessary complexity.

According to the invention, the object is achieved in that the DC voltage component which is produced by the transmitter for the differential transmission is used at the receiver end for information about the operating state of the transmitter.

According to the invention, the operating state of the transmitter is determined at the receiver end by means of a detector. When no transmitter is present or the transmitter is inactive, the detector controls the output of the receiver such that a predetermined value is not exceeded, or the receiver is entirely switched off.

The detector is connected symmetrically between the resistance which produces the voltage difference in the receiver [lacuna], and thus compares the DC voltage component Uc produced by the transmitter with a reference voltage Uref.

The detector may in this case be in the form of a differential amplifier with/without a threshold value decision maker, for example the detector may comprise a further receiver for differential data transmission, or transistor circuits in the form of bipolar or field effect transistor circuits.

In a further development of the invention, an upgraded detector is connected to each transmission line, so that the input voltages of each transmission path are compared with a reference voltage for the detector and are evaluated, and the evaluation of the state of each line is supplied to an OR logic operation, whose output controls the receiver and/or other assemblies.

The detector may in this case be formed from two differential amplifiers with/without a threshold value decision maker and their OR logic operations, for example the detector may comprise two further receivers for differential data transmission, or transistor circuits in the form of bipolar or field effect transistor circuits.

The invention suppresses radio-frequency oscillation of the receiver and of downstream assemblies, and prevents damage or destruction. There is no need for additional control lines to provide information about the operating state of the transmitter.

The invention can be implemented in the form of circuits or, if required, may be connected as external circuitry to the receiver, for example in the case of retrofits.

There is now no need to produce a bias voltage at the receiver, so that this overcomes the dependency of the difference voltage magnitude |Ud| or the data.

FIG. 2 illustrates one exemplary embodiment of the circuit arrangement according to the invention.

The data to be transmitted is supplied via the input to two outputs A and AN, which operate in mutually opposite senses, of the transmitter, and controls it.

The transmitter provides a current of an appropriate magnitude and direction, in order to produce the voltage Ud across the resistances R/2. At the same time, the transmitter produces a DC voltage component Uc, which is independent of the transmission and is constant, and provides the axis of symmetry for the eye opening at the receiver input.

The difference between the input voltages UE and UEN is formed in the receiver, and this corresponds to the total value across the resistances R/2.

The detector is connected between the resistances R/2, whose magnitudes are the same, and symmetrically loads the existing transmission path, compares the voltage Uc with a reference voltage Uref, and controls the receiver. The load ensures that a DC voltage component is detected only when the transmitter is in the active state. Furthermore, the magnitude of the difference voltage |Ud| is independent of the data. The reference voltage can in this case be chosen such that disturbances in the DC voltage component Uc do not lead to any interruption in the data transmission.

If the transmitter is not present or is inactive, that is to say when it is switched off or has a high impedance, the DC voltage component Uc is less than the reference voltage Uref. The receiver is controlled by the detector such that, for example, the receiver output emits a fixed value, or the receiver is switched off.

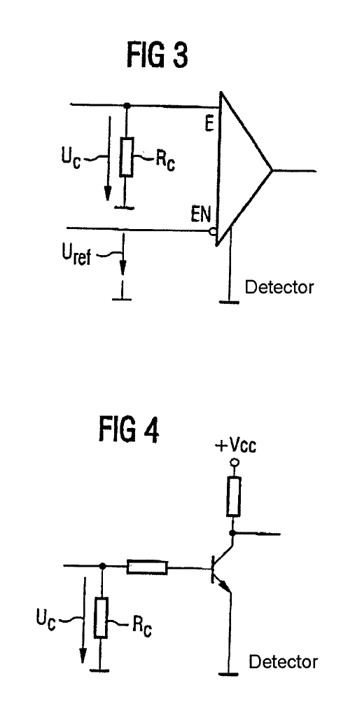

In a further embodiment of the invention, it is possible to use the detector, for example, as a differential amplifier with/without a threshold value decision maker, for example as a further receiver for differential data transmission (see FIG. 3). Bipolar or field effect transistor circuits (see FIG. 4) can likewise be used. In the case of a bipolar transistor circuit a “threshold value decision” is made, for example, at 0.7 V.

In a further embodiment of the invention, the interference susceptibility to disturbances in the DC voltage component Uc can be improved if, as in FIG. 5, the voltage Uc_Ud/2, on each individual transmission line is compared with a reference voltage Uref, and is evaluated. The evaluation of the state of each individual line is supplied, for example, to an OR logic operation, whose output is used to control the receiver and/or other assemblies.

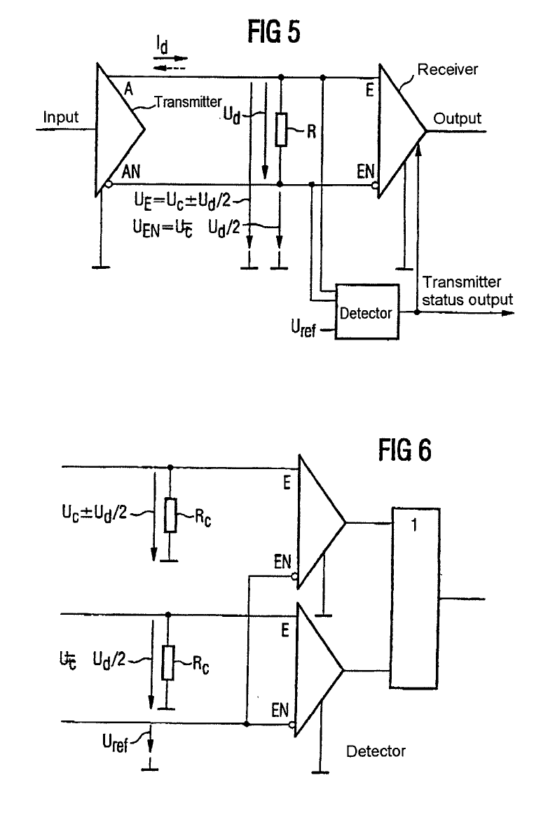

The upgraded detector which is illustrated in FIG. 6 identifies an active data transmission even when a DC voltage component Uc<0 V is present (for example caused by disturbances), provided that Uc+Ud/2 and superimposed disturbances exceed the reference voltage Uref on at least one line.

The minimum reference voltage Uref must be chosen such that disturbances on each individual line are reliably suppressed by the detector when the transmitter is not present or is inactive.

1. A method for monitoring data transmission by means of differential transmission methods with a DC voltage component, characterized
in that the DC voltage component which is produced by the transmitter for the differential transmission is used for information as to whether the operating state is or is not present, or whether the transmitter is active/inactive.

2. The method as claimed in claim 1, characterized
in that the operating state of the transmitter is determined at the receiver end by means of a detector.

3. The method as claimed in claims 1 and 2, characterized
in that, when no transmitter is present or the transmitter is inactive, the detector controls the receiver such that its output does not exceed a predetermined value, or switches off the receiver.

4. A circuit arrangement for carrying out the method as claimed in claims 1 to 3, characterized
in that the detector is connected symmetrically between the resistance which produces the voltage difference in the receiver [lacuna], and thus compares the DC voltage component Uc produced by the transmitter with a reference voltage Uref.

5. The circuit arrangement as claimed in claim 4, characterized
in that the detector comprises a differential amplifier with/without a threshold value decision maker.

6. The circuit arrangement as claimed in claim 4, characterized
in that the detector comprises a bipolar transistor circuit.
